(19) United States
(12) Patent Application Publication
(10) Pub. No.: US 2008/0018914 A1
(43) Pub. Date: Jan. 24, 2008

(54) Image Forming Apparatus, Memory Control Device and FIFO Memory Control Method

(75) Inventors: Yayoi DOI, Shizuoka-ken (JP); Kuniyoshi Takano, Kanagawa-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/456,558

(22) Filed: Jul. 10, 2006

(51) Int. Cl. G06F 3/12

(52) U.S. Cl. 358/1.1

(57) ABSTRACT

An image forming apparatus of the invention includes a memory circuit having plural FIFO memories connected in parallel, an image data generating unit that supplies image data formed of plural lines to the memory circuit, and a line counter that counts the number of lines of the image data supplied to the memory circuit. Moreover, the image forming apparatus includes a memory access control circuit that controls writing of the image data in the plural FIFO memories and periodically writes the image data sequentially supplied in the plural FIFO memories by shifting each of the image data by one line according to a count value of the line counter and an output selection circuit that simultaneously outputs a group of image data read out from the plural FIFO memories and rearranges the group of image data in order for each line according to a count value of the line counter to output the group of image data.

### BACKGROUND OF THE INVENTION

1. Field of the Invention

The present invention relates to image forming apparatuses such as an MFP (Multi-Function Peripherals), which is digital complex machine, and a copying machine and an image forming apparatus that subjects image data read by an image reading apparatus to arithmetic processing and makes it possible to print an image subjected to the arithmetic processing with a printer. The invention also relates to a memory control device and an FIFO memory control method that are used in performing the arithmetic processing.

2. Description of the Related Art

Conventionally, in an image forming apparatus such as an MFP, an image of an original is read by an image reading apparatus such as a scanner, arithmetic processing such as filtering is applied to image data read, and the image subjected to the arithmetic processing is printed by a printer. Examples of the arithmetic processing include high-pass filter processing and low-pass filter processing. It is possible to emphasize an outline of the image and represent the image sharply by applying the high-pass filter processing to the image data. It is possible to smooth the outline of the image by applying the low-pass filter processing to the image data.

In applying the arithmetic processing such as filtering to the image data, image data of plural lines read by the scanner or the like are simultaneously inputted to an arithmetic circuit. The arithmetic circuit performs a matrix operation using image data of a reference line and image data of lines before and behind the reference line.

In performing such a matrix operation, the image data read are inputted to FIFO (First In First Out) memories of a multi-stage constitution, the image data each delayed by one line are sequentially outputted from the respective FIFO memories, and the plural image data outputted from the respective FIFO memories are supplied to the arithmetic circuit. Access for writing of the image data in and readout of the image data from the respective FIFO memories is always performed repeatedly for each of the lines.

In general, in the image forming apparatus such as the MFP, the FIFO memories, a control device for the FIFO memories, and the arithmetic circuit are constituted in an ASIC (Application Specified IC). There is a deficiency in that, as the number of times of access for writing of the image data in and readout of the image data from the FIFO memories increases, power consumption of the ASIC increases. As the number of FIFO memories increases, the number of times of access also increases. Thus, there is a problem in that power consumption further increases.

An image forming apparatus using FIFO memories is described in JP-A-2005-74709. In this laid-open patent application, an example that includes exposing means for scanning a photosensitive member with plural beams, memory means for separating image data for plural output lines for each of the lines and outputting the image data, and driving means for driving the exposing means in accordance with the image data for each of the lines outputted from the memory means and uses plural FIFO memories as the memory means is described.

An image forming apparatus using FIFO memories is described in JP-A-2003-196154. In this laid-open patent application, an example that includes line memories that can hold image data for one line and exposing means for modulating a laser beam according to the image data read out from this line memory and exposing a photosensitive member with the laser beam modulated and uses FIFO memories as the line memories is described. In the case of this example, the FIFO memories are divided into plural sub-memory blocks and perform writing and readout control for each of the sub-memory blocks. However, power saving for the FIFO memories and arithmetic processing for the image data are not described in both the laid-open patent applications.

The invention provides an image forming apparatus and a memory control device that can reduce the number of times of writing access to FIFO memories and reduce power consumption.

### DESCRIPTION OF THE DRAWINGS

FIG. 1 is a block diagram showing a structure of an image forming apparatus according to an embodiment of the invention;

FIG. 2 is a block diagram for explaining a structure of an image processing unit of the image forming apparatus according to the embodiment of the invention;

FIG. 3 is a block diagram showing a structure of a memory control unit and an arithmetic processing unit used in the image processing unit of the invention;

FIG. 4 is a block diagram showing a detailed structure of the memory control unit in FIG. 3;

FIG. 5 is a timing chart for explaining operations of the memory control unit in the embodiment of the invention;

FIG. 6 is a table for explaining a writing operation in the memory control unit of the invention; and

FIG. 7 is a table for explaining a readout operation in the memory control unit of the invention.

### DETAILED DESCRIPTION OF THE INVENTION

Throughout this description, the embodiments and examples shown should be considered as exemplars, rather than limitations on the apparatus and methods of the present invention.

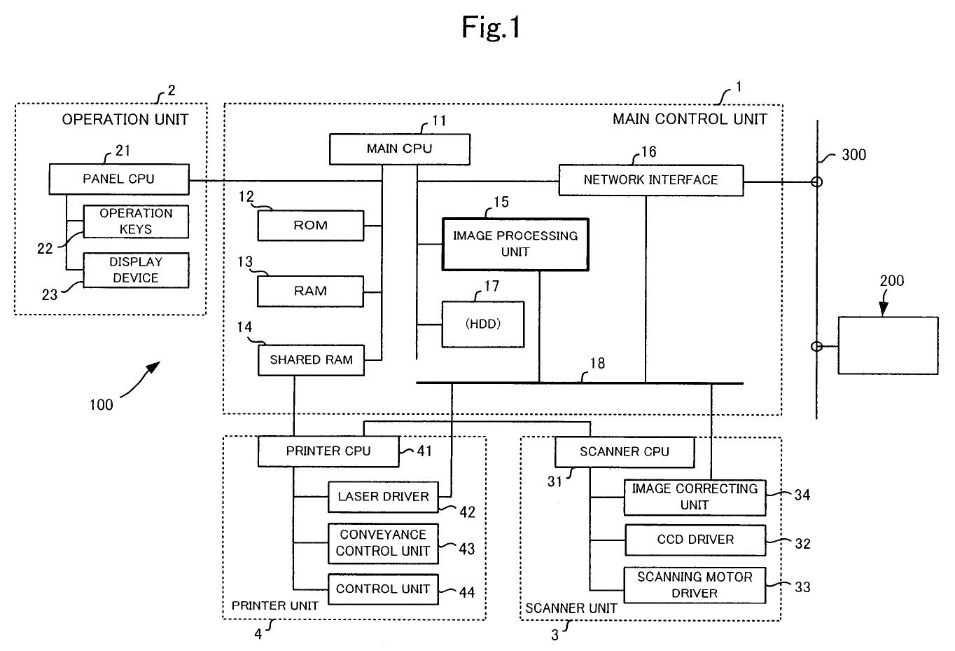

An embodiment of the invention will be hereinafter explained in detail with reference to the drawings. FIG. 1 is a block diagram showing an image forming apparatus according to an embodiment of the invention.

In FIG. 1, an image forming apparatus 100 is, for example, an MFP (Multi-Function Peripheral), which is a digital complex machine. This image forming apparatus 100 is connectable to an external apparatus 200 such as a PC (Personal Computer) and other apparatuses via a network 300 such as a LAN (Local Area Network). In the following explanation, the image forming apparatus 100 is explained with an MFP as an example. However, it is possible to apply the image forming apparatus 100 to a copying machine and the like.

The MFP 100 has a main control unit 1, an operation unit 2, a scanner unit 3, and a printer unit 4. A control system of the MFP 100 has plural CPUs including a main CPU 11 in the main control unit 1, a panel CPU 21 of the operation unit 2, a scanner CPU 31 of the scanner unit 3, and a printer CPU 41 of the printer unit 4.

The main control unit 1 includes the main CPU 11, a ROM (read only memory) 12, a RAM 13, a shared RAM 14, an image processing unit 15, a network interface 16, and an HDD 17 serving as a storage device. Reference numeral 18 denotes an image data bus.

The main CPU 11 controls operations of the entire MFP 100. A control program and the like are stored in the ROM 12. The RAM 13 temporarily stores a control program and data. The shared RAM 14 is used when two-way communication is performed between the main CPU 11 and the printer CPU 41. The image processing unit 15 processes image data read by the scanner unit 3 to perform processing such as filtering and includes plural FIFO memories.

The MFP 100 can transmit and receive image data to and from the PC 200 via the network interface 16 connected to the network 300. The HDD 17 temporarily stores image data processed by the image processing unit 15. An image based on the image data stored in the HDD 17 is printed on a sheet by the printer unit 4.

The operation unit 2 has the panel CPU 21 connected to the main CPU 11, various operation keys 22, and a display device 23 made of liquid crystal or the like. The operation keys 22 includes keys for performing various instructions for a print size, color printing or monochrome printing, and the like and designating intensity of sharpness and the like.

The scanner unit 3 irradiates light on an original placed on an original table with an exposure lamp, receives reflected light with a CCD to read an image of the original, and converts the image into image data. The scanner unit 3 has the scanner CPU 31 that controls operations of the entire scanner unit and a CCD driver 32 that drives a color image sensor. The scanner unit 3 includes a scanning motor driver 33 that controls a scanning motor for moving the exposure lamp along a lower surface of the original table and an image correcting unit 34.

The image correcting unit 34 includes an A/D conversion circuit that converts analog signals of R, G, and B outputted from the color image sensor into digital signals, respectively, and a shading correction circuit that corrects fluctuation in an output signal due to variation or the like of the color image sensor.

The printer unit 4 has the printer CPU 41 that controls operations of the printer unit, a laser driver 42 that drives a laser, a conveyance control unit 43 that controls conveyance of a sheet, and a control unit 44 that performs charging, development, and transfer.

The image processing unit 15, the network interface 16, the image correcting unit 34, and the laser driver 42 are connected by the image data bus 18.

The PC 200 provides the image forming apparatus 100 with print data. The PC 200 creates print data such as a text and a figure using application software. The print data created by the PC 200 is supplied to the image forming apparatus 100 via the network 300.

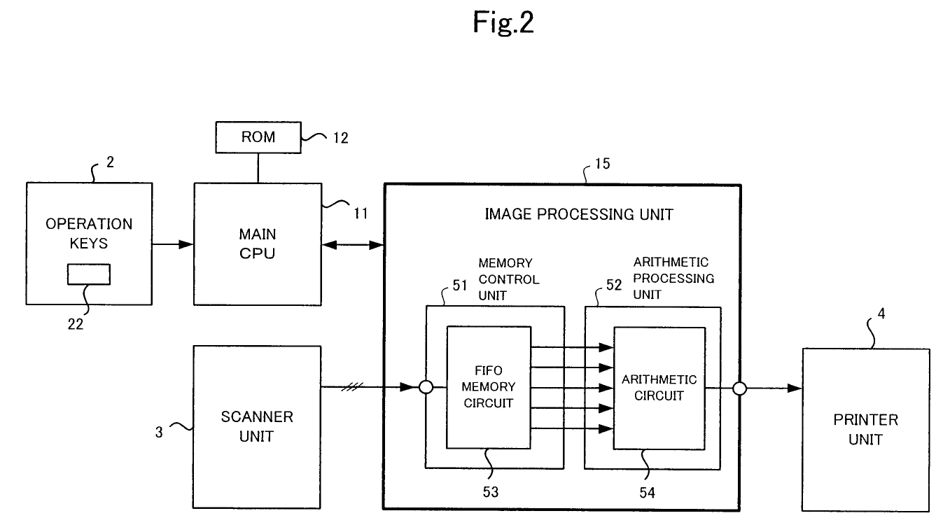

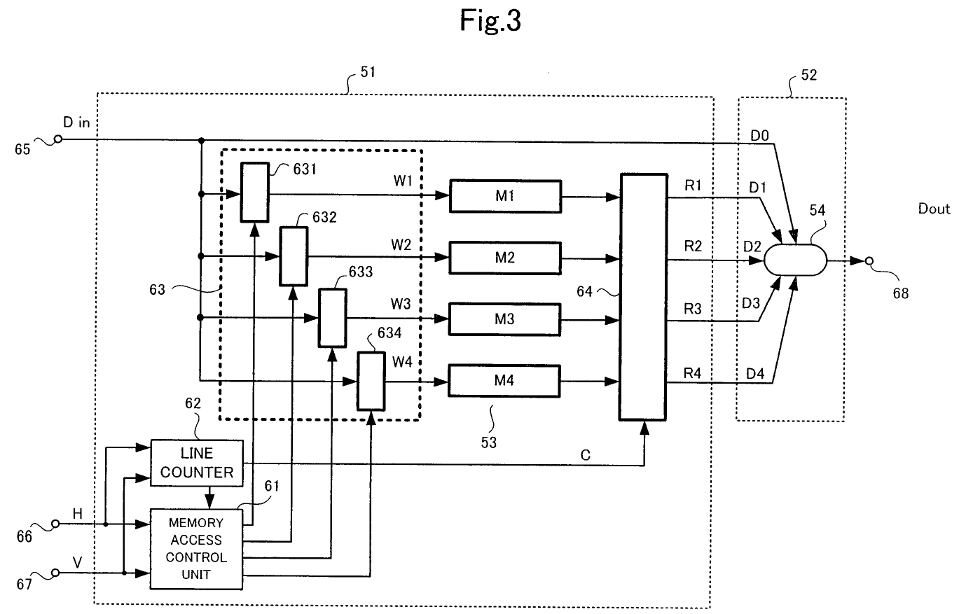

FIG. 2 is a block diagram schematically showing a structure of the image processing unit 15. In FIG. 2, the image processing unit 15 has a memory control unit 51 and an arithmetic processing unit 52. The memory control unit 51 includes a memory circuit 53. The arithmetic processing unit 52 includes an arithmetic circuit 54 that performs, for example, filtering processing, color conversion processing, and gradation processing. The memory circuit 53 includes plural (in this example, four) FIFO memories M1 to M4 (which will be explained with reference to FIG. 3).

Image data read by the scanner unit 3 are sequentially inputted to the memory circuit 53. Plural (in this example, for five lines) image data, each of which temporally shifted by one line, are simultaneously outputted from the memory circuit 53.

Image data of a line serving as a reference (hereinafter referred to as reference line data) and image data of plural lines before and behind the reference line data are supplied to the arithmetic circuit 54. The arithmetic circuit 54 applies matrix operations such as filtering processing, color conversion processing, and gradation processing to the respective image data inputted. An output of the arithmetic circuit 54 is supplied to the printer unit 4.

The operation unit 2 and the ROM 12 are connected to the main CPU 11. It is possible to indicate intensity of sharpness and the like with the operations keys 22 of the operation unit 2. A filtering coefficient and the like for the filtering processing are stored in the ROM 12. Since a method of the matrix operations in the arithmetic circuit 54 is a well-known technique and is not an aim of the invention, a detailed explanation of the method is omitted.

FIG. 3 is a block diagram showing a specific structure of the memory control unit 51 and the arithmetic processing unit 52 in FIG. 2.

The memory control unit 51 uses four FIFO memories M1, M2, M3, and M4 in the memory circuit 53. The memory control unit 51 has a memory access control circuit 61, a line counter 62, an input selection circuit 63, an output selection circuit 64, and input terminals 65, 66, and 67.

The scanner unit 3 repeats main scanning (line scanning) plural times while performing sub-scanning once to read an image of an original and sequentially supplies image data Din for each line read to the input terminal 65 of the memory control unit 51. The scanner unit 3 supplies a line synchronization signal H generated on the basis of the main scanning to the input terminal 66 and supplies a sub-scanning area signal V representing an image effective area generated on the basis of the sub-scanning to the input terminal 67.

The line synchronization signal H and the sub-scanning area signal V are inputted to the memory access control circuit 61 and the line counter 62, respectively. The line counter 62 counts the number of lines of the input image data Din using the line synchronization signal H and the sub-scanning area signal V and outputs a counter value of the number of lines. The memory access control circuit 61 creates ON/OFF control signals for memory access to the FIFO memories M1 to M4 using the line synchronization signal H, the sub-scanning area signal V, and the counter value from the line counter 62.

The input selection circuit 63 selects the FIFO memories, in which the input image data Din are written, in order. The input selection circuit 63 includes plural selectors 631 to 634 and performs control to select one of the FIFO memories M1 to M4 in order according to the ON/OFF control signals for memory access and write the input image data Din in order.

In the writing of the image data in the FIFO memories, the number of lines of input image data is counted and, for example, a first line of the input image data is written in the FIFO memory M1 and a second line is written in the FIFO memory 2. A third line is written in the FIFO memory M3 and a fourth line is written in the FIFO memory M4.

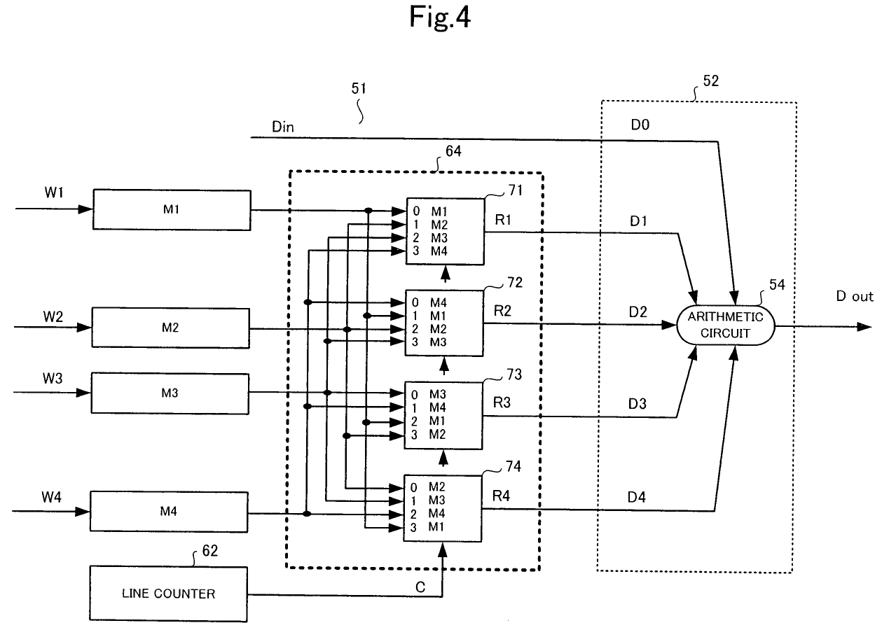

The output selection circuit 64 selects readout of image data from the FIFO memories M1 to M4 according to a counter value of the line counter 62. A detailed structure and operations of the output selection circuit 64 will be explained with reference to FIG. 4 later.

In FIG. 3, image data written in the respective FIFO memories M1, M2, M3, and M4 via the input selection circuit 63 are represented by W1, W2, W3, and W4. Image data read out from the FIFO memories M1, M2, M3, and M4 and selected and outputted from the output selection circuit 64 are represented by R1, R2, R3, and R4.

Image data D0 to D4 for five lines are simultaneously inputted to the arithmetic circuit 54 of the arithmetic processing unit 52. Among the image data D0 to D4 for five lines, D0 corresponds to the input image data Din inputted to the input terminal 65 and D1 to D4 correspond to the data R1 to R4 outputted from the output selection circuit 64.

The arithmetic circuit 54 applies a matrix operation such as filter processing to the respective image data D0 to D4 inputted and outputs image data Dout subjected to the arithmetic processing from the output terminal 68.

FIG. 4 is a diagram specifically showing an example of the output selection circuit 64 of the memory control unit 51. In FIG. 4, the output selection circuit 64 includes four selectors 71, 72, 73, and 74. Each of the selectors 71 to 74 includes four input terminals indicated by numbers 0 to 3. Output terminals of the FIFO memories M1 to M4 are connected to different input terminals of the selectors 71 to 74, respectively.

For example, in the selector 71, the input terminal 0 is connected to the output terminal of the FIFO memory M1, the input terminal 1 is connected to the output terminal of the FIFO memory M2, the input terminal 2 is connected to the output terminal of the FIFO memory M3, and the input terminal 3 is connected to the output terminal of the FIFO memory M4.

The input terminals 0, 1, 2, and 3 of the selector 72 are connected to the output terminals of the FIFO memories M4, M1, M2, and M3, respectively. The input terminals 0, 1, 2, and 3 of the selector 73 are connected to the output terminals of the FIFO memories M3, M4, M1, and M2, respectively. The imputer terminals 0, 1, 2, and 3 of the selector 74 are connected to the output terminals of the FIFO memories M2, M3, M4, and M1, respectively.

Sings M1 to M4 affixed beside the input terminals 0, 1, 2, and 3 of the respective selectors 71 to 74 indicate to which FIFO memories M1 to M4 the respective input terminals 0, 1, 2, and 3 are connected. In this way, the input terminals 0, 1, 2, and 3 of the respective selectors 71 to 74 are connected to the output terminals of the FIFO memories M1 to M4 while being sequentially shifted.

The selectors 71 to 74 select and output one of the image data supplied to the input terminals 0, 1, 2, and 3. The selectors 71 to 74 are subjected to selection control according to a counter value of the line counter 62.

For example, when the counter value is 1, the selectors 71 to 74 select and output image data inputted to the input terminals 3 thereof, respectively. When the counter value is 2, the selectors 71 to 74 select and output image data inputted to the input terminals 0 thereof, respectively. When the counter value is 3, the selectors 71 to 74 select and output image data inputted to the input terminals 1, respectively. When the counter value is 4, the selectors 71 to 74 select and output image data inputted to the input terminals 2, respectively.

When the counter value increases to 5, the selectors 71 to 74 select and output image data inputted to the input terminals 3 thereof again. Subsequently, the selectors 71 to 74 cyclically repeat the same selection operation according to an increase in the counter value.

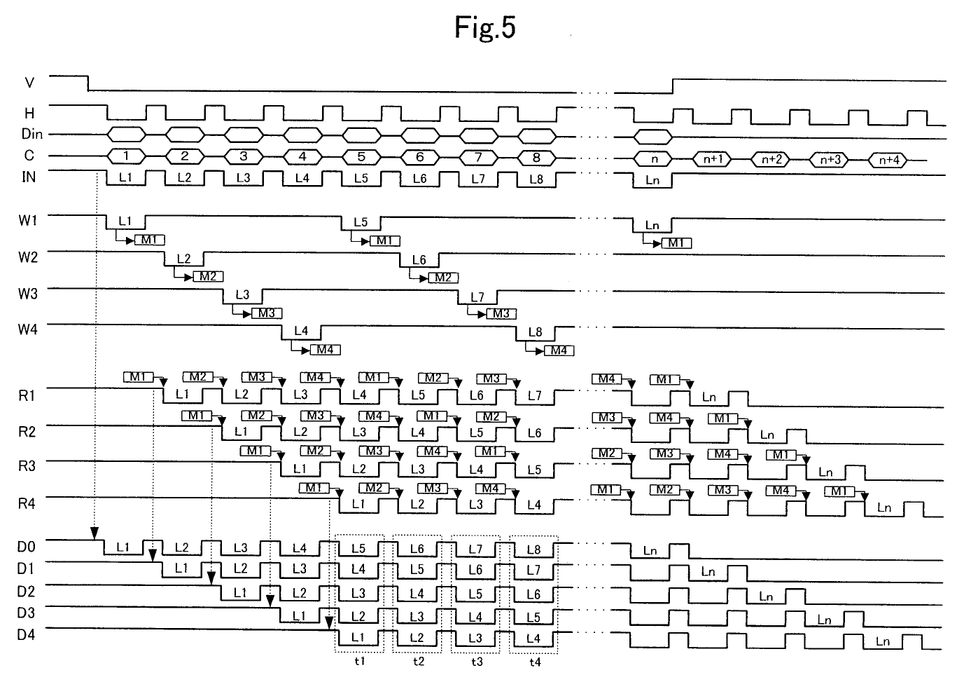

FIG. 5 is a timing chart for explaining operations of the circuits in FIGS. 3 and 4. In FIG. 5, the number of input image lines n is a multiple of 4+1.

In FIG. 5, V indicates a sub-scanning area signal inputted to the input terminal 67, H indicates a line synchronization signal inputted to the input terminal 66, and Din indicates input image data supplied to the input terminal 65. C indicates a counter value of the line counter 62. The counter value is indicated by the number of lines of numbers 1 to n+4. IN indicates input timing of the image data Din inputted to the input terminal 65. Image data of lines indicated by L1 to Ln are sequentially inputted to the input terminal 65.

W1 to W4 indicate writing timing of image data in the FIFO memories M1, M2, M3, and M4. R1 to R4 indicate output timing of the output selection circuit 64. It is indicated that image data read out from the FIFO memories M1, M2, M3, and M4 are outputted at timing of R1 to R4. D0 to D4 indicate input timing of image data to the arithmetic circuit 54.

Writing of image data in the FIFO memories M1, M2, M3, and M4 is selected by the input selection circuit 63. The image data are sequentially written in any one of the FIFO memories. At the timing of W1, the image data of the lines L1, L5, and the like are written in the FIFO memory M1. At the timing of W2, the image data of the lines L2, L6, and the like are written in the FIFO memory M2. At the timing of W3, image data of the lines L3, L7, and the like are written in the FIFO memory M3. At the timing of W4, the image data of the lines L4, L8, and the like are written in the FIFO memory M4.

The memory access control circuit 61 outputs memory access signals to the FIFO memories M1, M2, M3, and M4 and controls any one of the FIFO memories to come into an enable state. At the timing of W1 to W4, the memory access control circuit 61 writes image data in the FIFO memories M1, M2, M3, and M4.

In this way, the image data each shifted by one line are periodically written in the FIFO memories M1 to M4 once in four lines. Consequently, the number of times of access of writing is reduced.

On the other hand, the image data written in the FIFO memories M1, M2, M3, and M4 are read out in order from data written first and supplied to the output selection circuit 64. The output selection circuit 64 selects the image data inputted to the input terminals 0 to 3 of the four selectors 71, 72, 73, and 74 according to a count value of the line counter 62 and outputs the image data in order.

At a certain count value, the selector 71 selects an output of the FIFO memory M1, the selector 72 selects an output of the FIFO memory M4, the selector 73 selects an output of the FIFO memory M3, and the selector 74 selects an output of the FIFO memory M2. At the next count value, the selector 71 selects an output of the FIFO memory M2, the selector 72 selects an output of the FIFO memory M1, the selector 73 selects an output of the FIFO memory M4, and the selector 74 selects an output from the FIFO memory M3.

In this way, the selectors 71 to 74 rearrange the group of image data (D1 to D4), which are read out from the FIFO memories M1, M2, M3, and M4, in order for each line and output the image data in accordance with the progress of the count of the line counter 62. As a result, readout is executed at the timing indicated by R1 to R4 in FIG. 5. The group of image data (D1 to D4) from the selectors 71 to 74 and the image data D0 corresponding to the input image data Din are supplied to the arithmetic circuit 54.

The group of image data (D1 to D4) shifted in order for each line are simultaneously outputted from the selectors 71 to 74 of the output selection circuit 64. The respective image data delayed in line from the FIFO memories M1, M2, M3, and M4 are rearranged and supplied to the arithmetic circuit 54.

As indicated by timing t1, t2, t3, and t4 in FIG. 5, the image data of the five lines each shifted by one line are supplied to the arithmetic circuit 54. The arithmetic circuit 54 performs, with data D2 set as a reference line data, arithmetic processing using the image data D0 and D1 and the image data D3 and D4 of two lines before and behind the data D2.

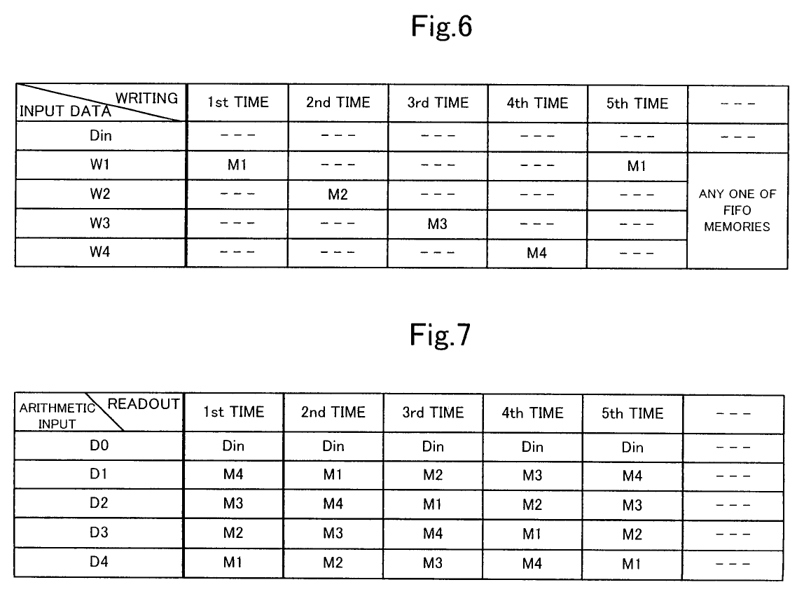

FIG. 6 is a table showing a relation between the input image data Din and image data written in the FIFO memories M1 to M4. Writing access to the FIFO memories M1 to M4 is performed at a ratio of once in four lines. Therefore, it is unnecessary to perform writing for each of all the lines. Writing access is performed periodically. Consequently, it is possible to reduce the number of times of access of writing in the FIFO memories M1 to M4 and reduce electric power consumed in the memory control unit 51.

FIG. 7 is a table showing a relation between the image data D0 to D4 inputted to the arithmetic circuit 54 and image data read out from the FIFO memories M1 to M4. The image data D0 is the input image data Din. The image data D1 to D4 are read out from the different FIFO memories M1 to M4 for each of the lines.

As described above, in the image forming apparatus of the invention, writing access to the FIFO memories only has to be performed once for four lines with respect to any one of the FIFO memories. When the image processing unit 15 is constituted by an ASIC, it is possible to reduce power consumption by reducing the number of times of access to the FIFO memories.

In the example explained above, the image data for five lines are supplied to the arithmetic circuit 54. However, it is also possible that image data for seven lines are simultaneously inputted to the arithmetic circuit 54, image data of a fourth line is set as reference line data, and arithmetic processing is performed using image data of three lines before and three lines behind the reference line data. Alternatively, it is also possible that image data for three lines are simultaneously inputted to the arithmetic circuit 54, image data of a second line is set as reference line data, and arithmetic processing is performed using image data of one line before and one line behind the reference line data.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
a memory circuit having plural FIFO memories connected in parallel;
an image data generating unit configured to generate image data formed of plural lines and sequentially supply the image data to the memory circuit;
a line counter configured to count a number of lines of the image data supplied to the memory circuit;
a memory access control circuit configured to control writing of the image data in the plural. FIFO memories and periodically write the image data sequentially supplied in the plural FIFO memories by shifting each of the image data by one line according to a count value of the line counter;
an output selection circuit configured to simultaneously output a group of image data read out from the plural FIFO memories and rearrange the group of image data in order for each line according to a count value of the line counter to output the group of image data;
an arithmetic circuit configured to be inputted with the image data supplied to the memory circuit and the group of image data outputted from the output selection circuit, respectively, and subject image data of plural different lines to arithmetic processing to output the image data; and
a printer unit configured to subject the image data, which are subjected to the arithmetic processing by the arithmetic circuit, to print processing.

2. An image forming apparatus according to claim 1, further comprising an input selection circuit configured to select an input of the image data to the plural FIFO memories, wherein
the input selection circuit selects any one of the plural FIFO memories in order according to a count value of the line counter and supplies the image data to the FIFO memory selected for each line.

3. An image forming apparatus according to claim 1, wherein
the memory circuit has n (n is equal to or larger than 1) FIFO memories, and
the memory access control circuit periodically writes the image data sequentially supplied in the n FIFO memories at a ratio of once in n lines by shifting each of the image data by one line according to a count value of the line counter.

4. An image forming apparatus according to claim 1, wherein
the plural image data inputted to the arithmetic circuit are image data for m lines (m is equal to or larger than 2), and
the arithmetic circuit subjects image data of a reference line in a center and image data of plural lines before and behind the reference line to arithmetic processing to output the image data.

5. An image forming apparatus according to claim 1, wherein the image data generating unit is constituted by a reading device that repeats main scanning plural times to read an image of an original.

6. An image forming apparatus according to claim 1, wherein
the image data generating unit repeats main scanning plural times to read an image of an original and generates image data and line synchronization signals, and
the line counter counts the line synchronization signals.

7. An image forming apparatus according to claim 1, wherein
the output selection circuit is constituted by plural selectors each having plural input terminals and one output terminal, inputs plural image data read out from the plural FIFO memories to the plural input terminals of the selectors, respectively, selects any one of the image data supplied to the plural input terminals in order in accordance with progress of the count of the line counter to output the image data from the output terminal, and simultaneously obtains a group of image data, each of which is shifted by one line, from the output terminals of the plural selectors.

8. An image forming apparatus comprising:
a memory circuit having plural FIFO memories connected in parallel;
an image data generating unit configured to repeat main scanning plural times to read an image of an original, generate image data formed of plural lines and line synchronization signals, and sequentially supply the image data and the line synchronization signals to the memory circuit;
a line counter configured to count the line synchronization signals supplied to the memory circuit;
a memory access control circuit configured to control writing of the image data in the plural FIFO memories and periodically write the image data sequentially supplied in the plural FIFO memories by shifting each of the image data by one line according to a count value of the line counter;
an output selection circuit configured to simultaneously output a group of image data read out from the plural FIFO memories and rearrange the group of image data in order for each line according to a count value of the line counter to output the group of image data;
an arithmetic circuit configured to be inputted with the image data supplied to the memory circuit and the group of image data outputted from the output selection circuit, respectively, and subject image data of a reference line in a center and image data of lines before and behind the reference line to arithmetic processing to output the image data; and
a printer unit configured to subject the image data, which are subjected to the arithmetic processing by the arithmetic circuit, to print processing.

9. A memory control device comprising:
a memory circuit having plural FIFO memories connected in parallel;
image data supplying means for sequentially supplying image data formed of plural lines to the memory circuit;
a line counter configured to count a number of lines of the image data supplied to the memory circuit;
a memory access control circuit configured to control writing of the image data in the plural FIFO memories and periodically write the image data sequentially supplied in the plural FIFO memories by shifting each of the image data by one line according to a count value of the line counter; and
an output selection circuit configured to simultaneously output a group of image data read out from the plural FIFO memories and rearrange the group of image data in order for each line according to a count value of the line counter to output the group of image data.

10. A memory control device according to claim 9, further comprising an input selection circuit configured to select an input of the image data to the plural FIFO memories, wherein
the input selection circuit selects one of the plural FIFO memories in order according to a count value of the line counter and supplies the image data to the FIFO memory selected for each line.

11. A memory control device according to claim 9, wherein
the memory circuit has n (n is equal to or larger than two) FIFO memories, and
the memory access control circuit periodically writes the image data sequentially supplied in the n FIFO memories at a ratio of once in n lines by shifting each of the image data by one line according to a count value of the line counter.

12. A memory control device according to claim 9, wherein
the output selection circuit is constituted by plural selectors each having plural input terminals and one output terminal, inputs plural image data read out from the plural FIFO memories to the plural input terminals of the selectors, respectively, selects any one of the image data supplied to the plural input terminals in order in accordance with progress of the count of the line counter to output the image data from the output terminal, and simultaneously obtains a group of image data, each of which is shifted by one line, from the output terminals of the plural selectors.

13. An FIFO memory control method comprising:
providing plural FIFO memories connected in parallel;
sequentially supplying image data formed of plural lines to the memory circuit and counting a number of lines of the image data supplied to the memory circuit;
controlling writing of the image data in the plural FIFO memories and periodically writing the image data sequentially supplied in the plural FIFO memories by shifting each of the image data by one line according to a count value of the number of lines; and
simultaneously outputting a group of image data read out from the plural FIFO memories and rearranging the group of image data in order for each line according to a count value of the number of lines to output the group of image data.

14. An FIFO memory control method according to claim 13, wherein, in inputting the image data to the plural FIFO memories, any one of the plural FIFO memories is selected in order according to a count value of the number of lines and the image data is supplied to the FIFO memory selected for each line.

15. An FIFO memory control method according to claim 13, wherein
n (n is equal to or larger than two) FIFO memories are provided, and
the image data sequentially supplied are periodically written in the n FIFO memories at a ratio of once in n lines by shifting each of the image data by one line according to a count value of the line counter.
